(19) United States
(12) Patent Application Publication
(10) Pub. No.: US 2024/0277551 A1
(43) Pub. Date: Aug. 22, 2024

(54) PARKINSON'S ASSISTANCE CANE

(71) Applicant: Central Components Inc., Tucson, AZ (US)

(72) Inventor: Peter Duran, Tucson, AZ (US)

(21) Appl. No.: 18/171,476

(22) Filed: Feb. 20, 2023

(51) Int. Cl. A61H 3/02; A45B 3/02; A45B 7/00; A45B 9/04

(52) U.S. Cl. CPC A61H 3/0288; A45B 3/02; A45B 7/005; A45B 9/04; A45B 2009/007

(57) ABSTRACT

The present invention features a configurable cane comprising a shaft comprising a first end and a second end, and an auxiliary leg attached at the second end of the shaft. The auxiliary leg may be configured to shift between a first position and a second position. The first position may comprise the auxiliary leg folded into the shaft, and the second position may comprise the auxiliary leg extending from the shaft. The cane may further comprise a light source near the auxiliary leg. The cane may further comprise a button disposed on the shaft near the first end, operatively coupled to the auxiliary leg. The button may be configured to operate the light source.

### FIELD OF THE INVENTION

The present invention is directed to a configurable cane for assistance to individuals with a physical condition hindering their balance and/or leg strength as a result of a disability, injury, or other medical condition.

### BACKGROUND OF THE INVENTION

Canes are a commonly used device for individuals that have minor problems with balance or stability, some weakness in their leg or trunk, an injury, or a pain. Elderly people may use a single point cane to help with comfortable movement and may make it easier for the elderly to continue living independently.

There exist many different categories of canes, but the primary distinction is between single-point canes and multiple-point canes. Single-point canes are lighter, more mobile, and easier to store but do not provide as much support as a multiple-point cane. Some people may require the use of a multiple-point cane at some times, for instance early points of recovery from an injury, and a single-point cane at other times, like at the later stages of recovery. Thus, there exists a present need for a single cane that is configurable to have the benefits of both single-point and multiple-point canes.

### BRIEF SUMMARY OF THE INVENTION

It is an objective of the present invention to provide devices that allow for a configurable cane for assistance to individuals with a physical condition hindering their balance and/or leg strength as a result of a disability, injury, or other medical condition, as specified in the independent claims. Embodiments of the invention are given in the dependent claims. Embodiments of the present invention can be freely combined with each other if they are not mutually exclusive.

The present invention features a configurable cane comprising a handle, and a shaft comprising a first end and second end. The first end may be coupled to the handle. The shaft may further comprise a cavity at the second end. The cane may further comprise an auxiliary leg attached at the second end of the shaft by a joint. The auxiliary leg may be configured to shift between a first position and a second position. The first position may comprise the auxiliary leg folded into the cavity of the shaft. The second position may comprise the auxiliary leg extending from the shaft. The cane may further comprise a light source disposed on the shaft near the auxiliary leg. The cane may further comprise a button disposed on the shaft near the first end, operatively coupled to the joint. The button may be configured to operate the light source.

One of the unique and inventive technical features of the present invention is the implementation of a light to illuminate an auxiliary leg of a cane operated by a button near the top of the cane. Without wishing to limit the invention to any theory or mechanism, it is believed that the technical feature of the present invention advantageously provides for aiding a user in operation of an auxiliary leg of the cane even in low-light environments, greatly preventing tripping or stumbling. None of the presently known prior references or work has the unique inventive technical feature of the present invention.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows a side view of the cane of the present invention in the first position.

FIG. 2 shows a close-up view of a telescopic mechanism of the cane of the present invention.

FIG. 3 shows a close-up view of the auxiliary leg of the cane of the present invention.

FIG. 4 shows a close-up view of the second end of the cane of the present invention.

FIG. 5 shows an isometric view of the cane of the present invention in the second position.

FIG. 6 shows a close-up view of the handle and first end of the cane of the present invention.

FIG. 7 shows a front view of the cane of the present invention in the first position.

FIG. 8 shows a side view of the cane of the present invention in the second position.

FIG. 9 shows a back view of the cane of the present invention in the first position.

### DETAILED DESCRIPTION OF THE INVENTION

Following is a list of elements corresponding to a particular element referred to herein:

| | |
|---|---|
| 100 | cane |
| 110 | handle |
| 120 | shaft |
| 121 | first end |
| 122 | second end |
| 130 | auxiliary leg |
| 131 | peg |
| 140 | button |
| 150 | cavity |
| 160 | light source |

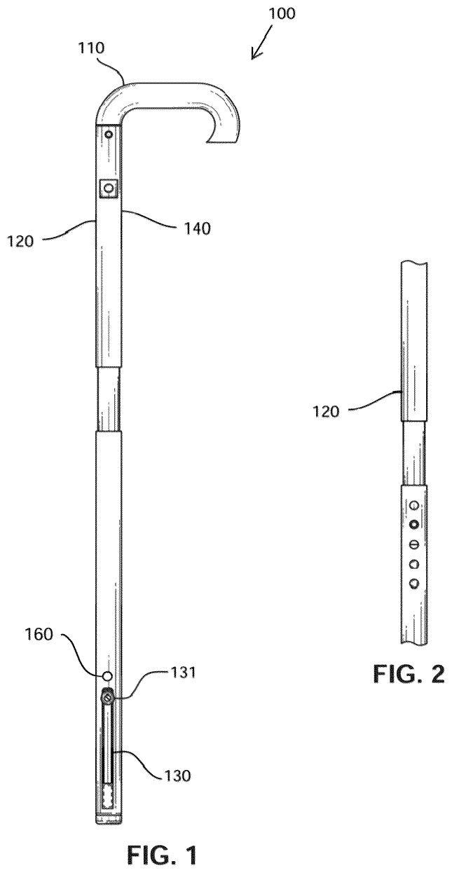

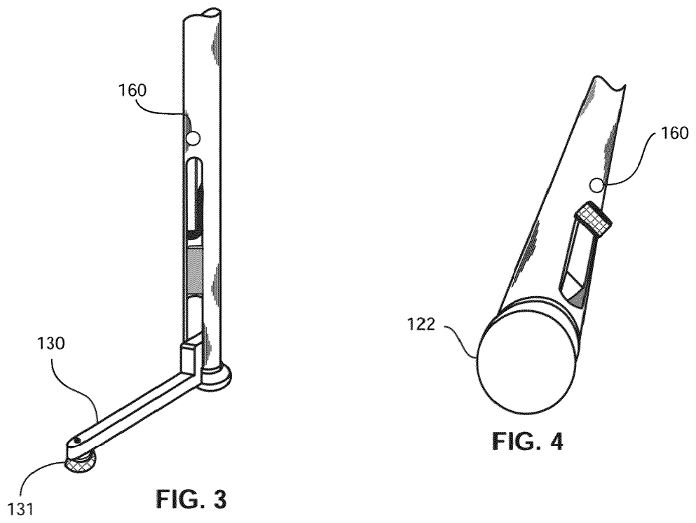

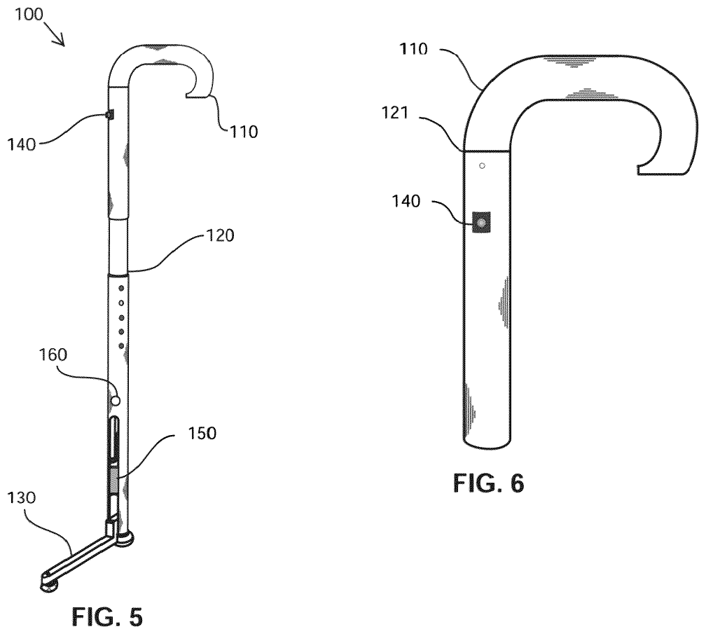

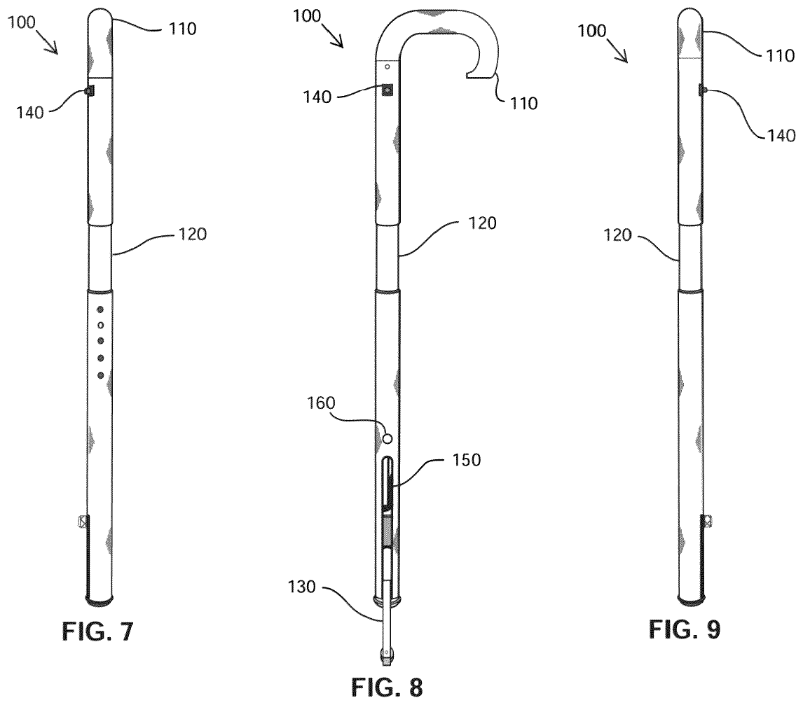

Referring now to FIGS. 1-10, the present invention features a configurable cane (100) comprising a shaft (120) comprising a first end (121) and a second end (122), and an auxiliary leg (130) attached at the second end (122) of the shaft (120). The auxiliary leg (130) may be configured to shift between a first position and a second position. The first position may comprise the auxiliary leg (130) folded into the shaft (120), and the second position may comprise the auxiliary leg (130) extending from the shaft (120). The cane (100) may further comprise a light source (160) disposed on the shaft (120) near the auxiliary leg (130). The cane (100) may further comprise a button (140) disposed on the shaft (120) near the first end (121), operatively coupled to the auxiliary leg (130). The button (140) may be configured to switch the light source (160) between an on and off configuration such that light is directed towards the auxiliary leg (130) in the second position.

In some embodiments, the cane (100) may further comprise a handle (110) extending from the first end (121) of the shaft (120). The handle (110) may extend at a 75 to 115 degree angle to the shaft (120). The cane (100) may further comprise a cavity (150) disposed at the second end (122) of the shaft (120). The first position may further comprise the auxiliary leg (130) folded into the cavity (150). The cavity (150) may comprise a first magnet, and the auxiliary leg may comprise a second magnet. The first magnet may be configured to attract the second magnet. This allows for the auxiliary leg (130) to lightly lock in place in the first position.

A material of the cane (100) may be plastic, aluminum, steel, or a combination thereof. In some embodiments, the shaft (120) may be telescopic. The auxiliary leg (130) may comprise a peg (131) extending perpendicular to the auxiliary leg (130) such that the peg (131) is level with the second end (122) of the shaft (120). In some embodiments, the peg (131) may extend at any angle relative to the auxiliary leg (130) that allows for the peg (131) to be level with the ground. In some embodiments, the auxiliary leg (130) extends perpendicular to the to shaft (120). In some embodiments, the auxiliary leg (130) extends at a 75 to 115 degree angle to the shaft (120).

In some embodiments, a length of the shaft may be 30 to 40 inches and a diameter of the shaft may be 3.5 to 4.5 inches.

In some embodiments, the handle may have a length of 4 to 6 inches and a diameter of 3.5 to 4.5 inches and may connect to the shaft at a 75 to 115 degree angle.

In some embodiments, the auxiliary leg may have a length of 4 to 6 inches and may extend from the shaft at a 75 to 115 degree angle.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A configurable cane (100) comprising a shaft (120) comprising a first end (121) and a second end (122), an auxiliary leg (130) attached at the second end (122) of the shaft (120), a light source (160) disposed on the shaft (120) near the auxiliary leg (130), and a button (140) disposed on the shaft (120) near the first end (121), operatively coupled to the light, wherein the auxiliary leg (130) is configured to shift between a first position and a second position, wherein the first position comprises the auxiliary leg (130) folded into the shaft (120), wherein the second position comprises the auxiliary leg (130) extending from the shaft (120), wherein the button (140) is configured to switch the light source (160) between an on and off configuration such that light is directed towards the auxiliary leg (130) in the second position.

2. The cane (100) of claim 1 further comprising a handle (110) extending from the first end (121) of the shaft (120).

3. The cane (100) of claim 2, wherein the handle (110) is at a 75 to 115 degree angle to the shaft (120).

4. The cane (100) of claim 1 further comprising a cavity (150) disposed at the second end (122) of the shaft (120).

5. The cane (100) of claim 4, wherein the first position further comprises the auxiliary leg (130) folded into the cavity (150).

6. The cane (100) of claim 1, wherein a material of the cane (100) is plastic, aluminum, steel, or a combination thereof.

7. The cane (100) of claim 1, wherein the shaft (120) is telescopic.

8. The cane (100) of claim 4, wherein the cavity (150) comprises a first magnet, wherein the auxiliary leg comprises a second magnet, wherein the first magnet is configured to attract the second magnet.

9. The cane (100) of claim 1, wherein the auxiliary leg (130) comprises a peg (131) extending perpendicular to the auxiliary leg (130), wherein the peg (131) is level with the second end (122) of the shaft (120).

10. A configurable cane (100) comprising:
a. a handle (110);
b. a shaft (120) comprising a first end (121) and second end (122), wherein the first end (121) is coupled to the handle (110), wherein the shaft (120) further comprises a cavity (150) at the second end (122);
c. an auxiliary leg (130) attached at the second end (122) of the shaft (120) by a joint, wherein the auxiliary leg (130) is configured to shift between a first position and a second position;
wherein the first position comprises the auxiliary leg (130) folded into the cavity (150) of the shaft (120);
wherein the second position comprises the auxiliary leg (130) extending from the shaft (120);
d. a light source (160) disposed on the shaft (120) near the auxiliary leg (130);
and e. a button (140) disposed on the shaft (120) near the first end (121), operatively coupled to the light;
wherein the button (140) is configured to switch the light source (160) between an on and off configuration such that light is directed towards the auxiliary leg (130) in the second position.

11. The cane (100) of claim 10, wherein a material of the cane (100) is plastic, metal, or a combination thereof.

12. The cane (100) of claim 10, wherein the shaft (120) is telescopic.

13. The cane (100) of claim 10, wherein the cavity (150) comprises a first magnet, wherein the auxiliary leg comprises a second magnet, wherein the first magnet is configured to attract the second magnet.

14. The cane (100) of claim 10, wherein the auxiliary leg (130) comprises a peg (131) extending perpendicular to the auxiliary leg (130), wherein the peg (131) is level with the second end (122) of the shaft (120).

15. The cane (100) of claim 10, wherein the handle (110) is at a 75 to 115 degree angle to the shaft (120).

16. A configurable cane (100) comprising:
a. a handle (110);
b. a telescopic shaft (120) comprising a first end (121) and second end (122), wherein the first end (121) is coupled to the handle (110), wherein the telescopic shaft (120) further comprises a cavity (150) at the second end (122);
c. an auxiliary leg (130) attached at the second end (122) of the telescopic shaft (120) by a joint, wherein the auxiliary leg (130) is configured to shift between a first position and a second position, wherein the auxiliary leg (130) comprises a peg (131) extending perpendicular to the auxiliary leg (130), wherein the peg (131) is level with the second end (122) of the shaft (120);
wherein the first position comprises the auxiliary leg (130) folded into the cavity (150) of the telescopic shaft (120);
wherein the second position comprises the auxiliary leg (130) extending perpendicular to the telescopic shaft (120);
d. a light source (160) disposed on the shaft (120) near the auxiliary leg (130); and
e. a button (140) disposed on the telescopic shaft (120) near the first end (121), operatively coupled to the light source (160);
wherein the button (140) is configured to switch the light source (160) between an on and off configuration such that light is directed towards the auxiliary leg (130) in the second position.

17. The cane (100) of claim 16, wherein a material of the cane (100) is plastic, metal, or a combination thereof.

18. The cane (100) of claim 16, wherein the handle (110) is at a 75 to 115 degree angle to the shaft (120).
